(19) United States
(12) Patent Application Publication
(10) Pub. No.: US 2003/0097787 A1
(43) Pub. Date: May 29, 2003

(54) Plant protector

(76) Inventor: Paul Brown, St. John's (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/262,981

(22) Filed: Oct. 3, 2002

(30) Foreign Application Priority Data
Oct. 3, 2001 (CA) 2,359,529

(51) Int. Cl. A01G 13/02

(52) U.S. Cl. 47/23.1

(57) ABSTRACT

A plant protector for protecting a plant during inclement weather includes a sheet of material with a top edge, a bottom edge and a trailing edge. The protector includes a hook and loop fastener system so that the protector can be wrapped about a plant and adhered to maintain it in place. Advantageously, the sheet can be of a typical size of three feet high by nine feet in length. For protecting plants more than three feet tall additional sheets can be joined at top and bottom edges using the hook and loop fastener. Similarly if the plant has a circumference greater than nine feet, one or more sheets can be adhered together at the leading and trailing edges using the hook and loop fasteners. Preferably the sheet material is burlap or other similar breathable fabric.

### FIELD OF THE INVENTION

This invention relates to a method and apparatus for protecting a plant from adverse elements.

### BACKGROUND OF THE INVENTION

Protective coverings for plants have been in use for many years. Protective coverings are used to protect plants from damage that plants would otherwise incur as a result of exposure to severe weather conditions, transportation, and pollutants. Protective coverings typically comprise a sheet of material, usually burlap, wrapped around a plant. A securing system is used to secure the sheet in place.

One of the problems with the conventional method of protecting plants is the way in which the protective material is secured around the plant. The systems often employed to secure the protective material around the plant include the use of twine, elastic chords, tape, or a wooden frame constructed around the plant to which a sheet is stapled. Though such methods attain the desired result, they only do so with the requirement of supporting materials and superfluous labour. Some of these materials, such as staples and tape, damage the sheet and cause wear and tear, ultimately reducing its lifespan. Furthermore, the negative aspects of conventional plant protection are compounded whenever it is necessary to tighten, loosen or remove the protective covering.

### SUMMARY OF THE INVENTION

In accordance with this invention, a plant protector comprises at least one sheet of material, the sheet of material having first and second surfaces and a periphery defined by a top edge, a bottom edge, a leadirig edge and a trailing edge. The plant protector includes a hook and loop fastener system including at least one strip of hook component portion and at least one strip of loop component portion. At least one of the strip of hook component portions is on one of the first and second surfaces of the sheet of material and at least one of the strip of loop component portions is on the other of the first and second surfaces of the material. The strips of hook and loop component portions are located on the surfaces of the sheet of material so as to be interengageable upon wrapping the sheet of material around at least a section of a plant to be protected. In a preferred embodiment of the invention, the hook and loop fastener system is located on the sheet so that at least some of the loop portion is engageable with at least some of the hook portion to hold the sheet of material in a tube configuration when the sheet is wrapped around a plant. In a further preferred embodiment of the invention, there is a composite protector comprising a plurality of protectors as described above. The protectors are located such that the hook and loop component portion on one of the plant protectors is interengageable with the loop and component portion on another one of the plant protectors. The plant protectors may be joined so that the trailing edge of one protector is joined to the leading edge of a second protector and they make an elongated composite protector. In addition, the protectors may be joined together with the bottom edge of a first protector joined to a top edge of a second protector so that the composite protector may include a plurality of protectors joined together as to be able to wrap a plant of desired size.

In accordance with another aspect of the invention, a method of protecting a plant comprises wrapping a sheet of material about the plant, the sheet having a hook component portion and a loop component portion and at least some of the hook component portion engages with at least some of the loop component portion. In a preferred embodiment, there may be a plurality of sheets. These are used to wrap a plant wherein the leading edge of one sheet is placed in adherence with the trailing edge of a second sheet and the elongated sheet is wrapped about the plant. In a further preferred embodiment of the invention, a method includes wrapping a plant with a plurality of sheets, whose material are used to wrap a plant and wherein the top edge of one sheet is attached to the bottom edge of a second sheet.

### BRIEF DESCRIPTION OF THE DRAWINGS

The figures illustrate preferred embodiments of a protector made in accordance with the invention and in which:

FIG. 1 is a planar view of the exterior surface of a protector.

FIG. 2 is a planar view of the interior surface of the protector of FIG. 1.

FIG. 3 is a perspective view of the protector of FIG. 1.

FIG. 4(a) is a plan view in section of the protector of FIG. 1 wrapped around an upright plant. FIG. 4(b) is a view of the hook-loop fastener connection of FIG. 4(a).

FIG. 5 is an elevational view of the protector of FIG. 1 wrapped around an upright plant.

FIGS. 6(a) and (b) are plan views of the protector of FIG. 1 wrapped around upright plants of different diameters.

FIGS. 7(a) and (b) are plan views in section of a plurality of protectors of FIG. 1 working in conjunction to wrap a plant.

FIGS. 8-10 depict alternate embodiments of the invention.

FIG. 8(a) is a planar view of the exterior side of an unwrapped plant protector in accordance with a first alternate embodiment. FIG. 8(b) is a planar view of the interior side of the unwrapped plant protector of FIG. 8(a). FIG. 8(c) is a perspective view of a plurality of plant protectors of FIG. 8(a), in the process of connection to increase the height of plant protection.

FIG. 9(a) is a planar view of the exterior of an unwrapped plant protector in accordance with a second alternate embodiment. FIG. 9(b) is a planar view of the interior of the unwrapped plant protector of FIG. 9(a).

FIG. 10(a) is a planar view of the interior of an unwrapped plant protector with attached hook straps in accordance with a third embodiment. FIG. 10(b) is a planar view of the exterior of the unwrapped plant protector of FIG. 10(a) with attached hook straps.

### DETAILED DESCRIPTION OF THE INVENTION

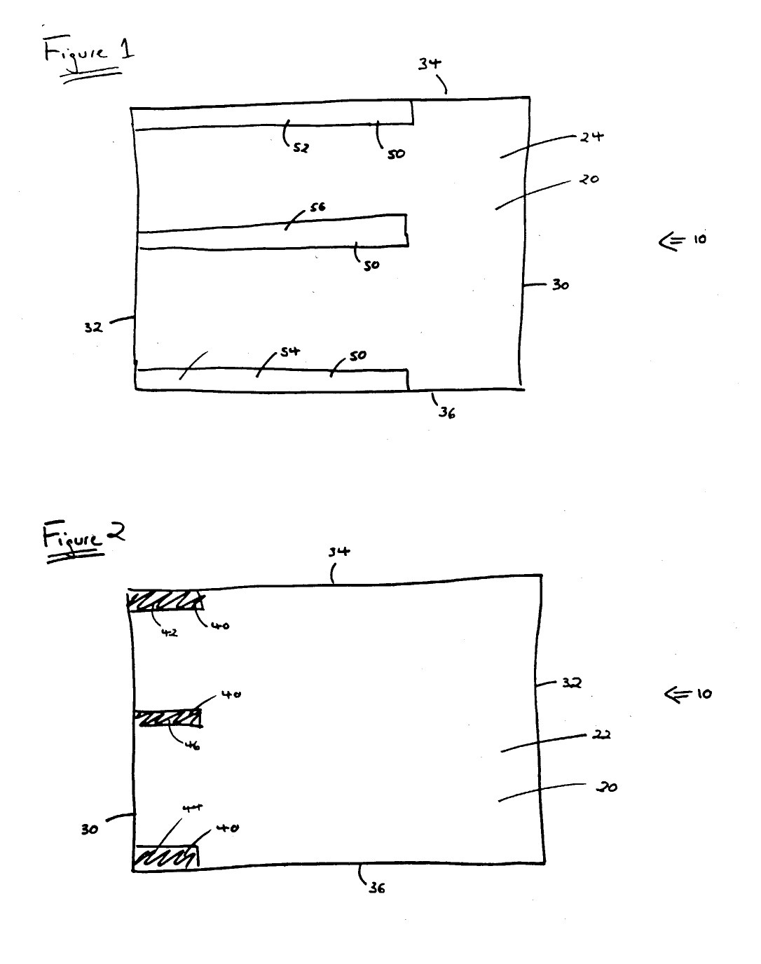

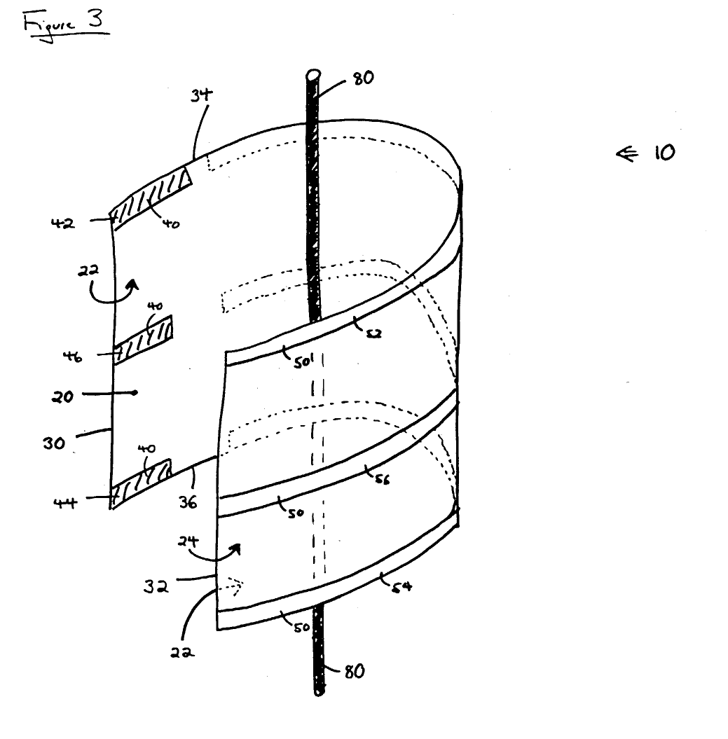

The embodiment of the invention illustrated in FIGS. 1 and 2 is directed to a protector 10 comprising a sheet 20 of material having first and second sides. One of the sides forms an interior surface 22, and the other side forms an exterior surface 24. The sheet 20 is generally rectangular and has a periphery defined by a leading edge 30, a trailing edge 32, a top edge 34, and a bottom edge 36. The length of the sheet 20 is defined by the distance between the leading edge 30 and the trailing edge 32. The height of the sheet 20 is defined by the distance between the top edge 34 and the bottom edge 36.

The system employed to secure the protector around a plant is a hook and loop fastener system, comprising at least one hook component portion, and at least one loop component portion. In the embodiments that follow, the hook and loop fastener system is comprised of hook strips 40 and loop strips 50.

As illustrated in the embodiment of FIG. 1, a plurality of loop strips 50 are affixed to the exterior surface 24 of the sheet 20 extending lengthwise, beginning at the trailing edge 32 of the sheet 20 and extending towards the leading edge 30 of the sheet 20. As will become evident, it is not necessary to have loop strips 50 extend all the way to the leading edge 30 of the sheet. While any number of loop strips 50 can be affixed to the exterior surface 24 of the sheet 20, it is preferable to have a top edge loop strip 52 extending adjacent a portion of the top edge 34 of the sheet 20, and one bottom edge loop strip 54 extending adjacent a portion of the bottom edge 36 of the sheet 20. Depending on the vertical dimension of the sheet 20, it may be desirable to have one or more intermediate loop strips 56 on the sheet 20 in between the top edge loop strip 52 and the bottom edge loop strip 54, in order to have the sheet 20 more securely affixed around the plant, and to prevent the sheet 20 from sagging. In the embodiment illustrated in FIG. 1, one such intermediate loop strip 56 is located in the middle of the sheet 20.

As illustrated in FIG. 2, hook strips 40 are affixed to the interior surface 22 of the sheet 20 extending lengthwise; beginning at the leading edge 30. As will become evident later, it is not necessary to have the hook strips 40 extend all the way to the trailing edge 32. While any number of horizontal hook strips 40 can be affixed to the interior surface 22 of the sheet 20, it is desirable to have a top edge hook strip 42 extending adjacent a portion of the top edge 34 of the sheet 20, and one bottom edge hook strip 44 extending adjacent a portion of the bottom edge 36 of the sheet 20. Intermediate hook strips 46 can be affixed to the sheet 20 in between the top edge hook strip 42 and the bottom edge hook strip 44. It is desirable to have the same number of intermediate hook strips 46 as there are intermediate loop strips 56. It is also desirable to have both intermediate hook strips 46 and intermediate loop strips 56 located such that the strips will be aligned for fastening once the sheet 20 is wrapped around a plant.

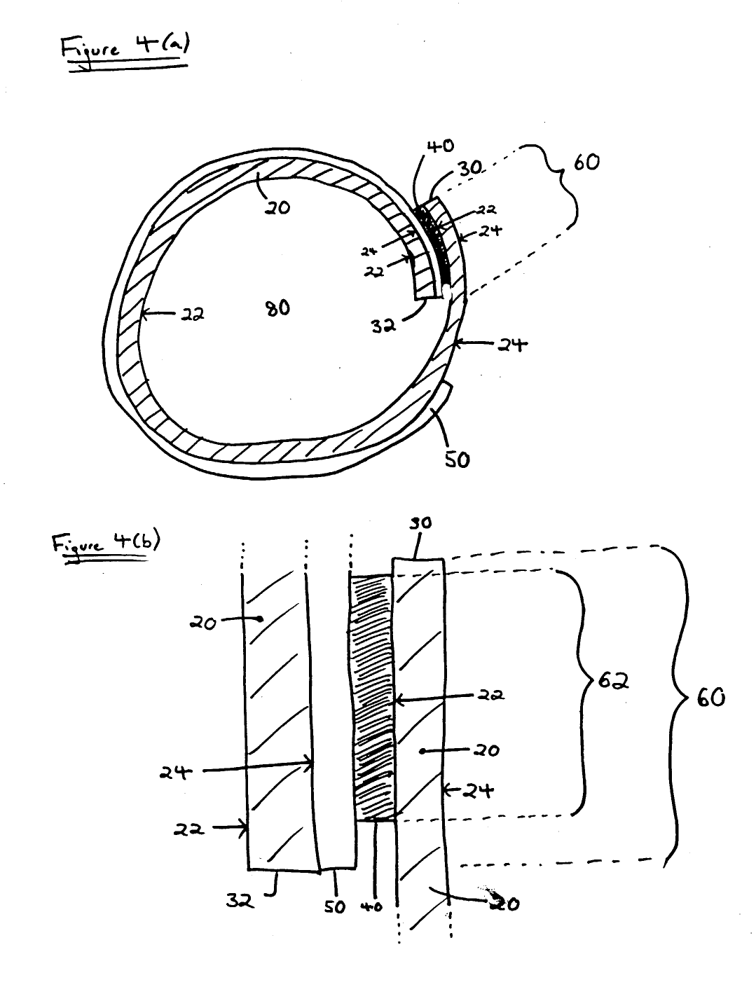

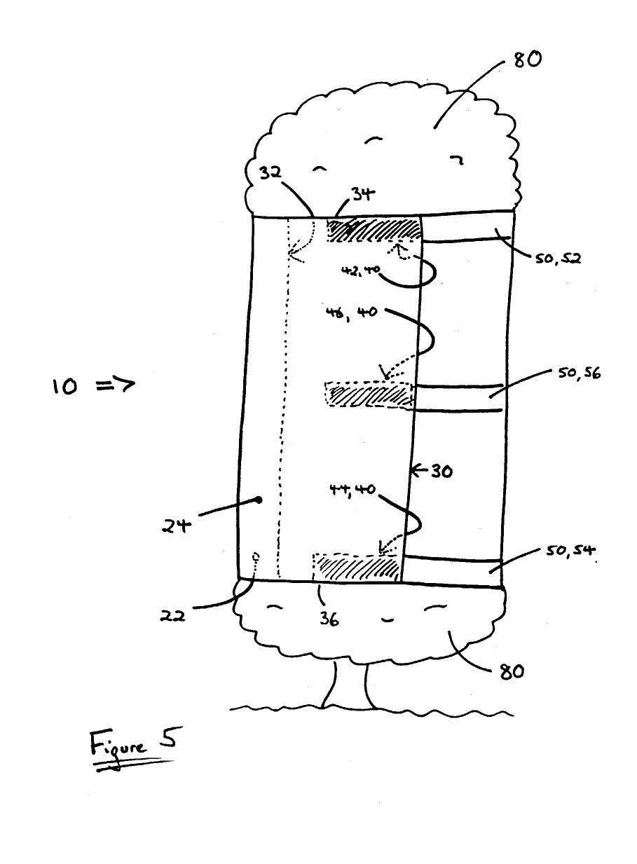

FIG. 3 is a perspective illustration of the protector 10 in a horseshoe shape, neither wrapped nor lying flat. The plant 80, represented in FIG. 3 by the vertical black cylindrical object, will be within the concave, or interior, portion of the horseshoe shaped protector 10. The way in which the protector 10 is fastened around the plant 80 is as follows: The interior surface 22 of the sheet 20 is the surface that makes contact with the plant 80. The interior surface 22 is placed against the plant 80, beginning with the trailing edge 32. With the trailing edge 32 held in place, the sheet 20 is then wrapped around the plant 80 circumferentially to form a tube. Eventually, the sheet 20 will envelop the plant 80, as illustrated in FIG. 4(a).

After the plant 80 is enveloped by the interior surface 22 of the sheet 20, there will remain an overlapping portion 60 of the sheet 20 defined by the portion of the interior surface 22 that covers the exterior surface 24, as depicted in FIGS. 4(a) and (b). It is this overlapping portion 60 that enables the hook strips 40 to make a connection with the loop strips 50, thereby securing the protector 10 around the plant 80. Upon the completion of wrapping, the hook strips 40 on the interior surface 22 are pressed against the loop strips 50 of the exterior surface 24, creating a hook and loop fastening bond 62, as illustrated in FIG. 4(b), securing the protector 10 in place. The end result is the creation of a tube shaped protective cover enveloping a plant, as illustrated in FIG. 5.

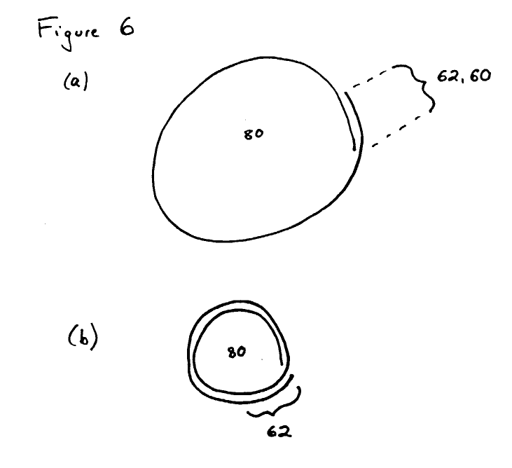

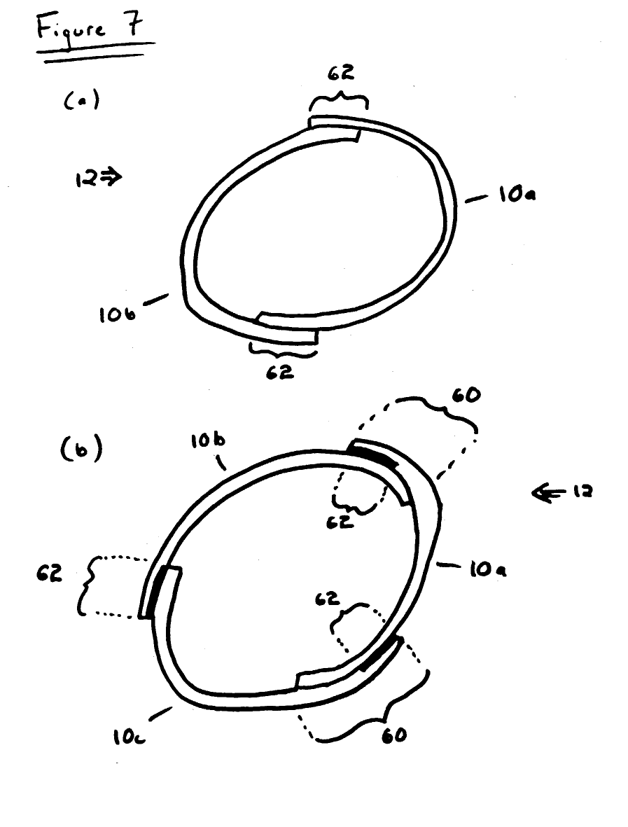

The length of the loop strips may extend almost completely along the length of the sheet 20, providing the flexibility to use a single protector 10 for a range of plants 80 varying in diameter, as illustrated in FIGS. 6(a) and 6(b). A plant 80 may have a circumference which, once enveloped, leaves a portion of overlapping surface 60 which is just enough to enable engagement of the loop strips 50 with the hook strips 40, as illustrated in FIG. 6(a). It is thus desirable to have affixed loop strips 50 beginning at the trailing edge 32, and the hook strips 40 beginning at the leading edge 30, as depicted in FIGS. 1 and 2, in order to enable securement of the sheet for use with a plant with such a large diameter. In order to enable protection of plants with circumferences smaller than that depicted in FIG. 6(a), it is desirable to increase the length of the loop strips 50 towards the leading edge 30. As the diameter of desired plants one wishes to be able to envelop decreases, so too must the length of the loop strips 50 increase from the trailing edge 32 toward the leading edge 30. It is not necessary to have the loop strips 50 extend all the way to the leading edge 30, as it is highly unlikely that the hook strips 40 would not be able to engage with the loop strips 50, after an extensive overlap around a plant with a comparatively small diameter.

Generally speaking, the length of the hook strips 40 is much shorter than the length of the loop strips 50 in this embodiment. The hook strips 40 are simply long enough so as to ensure that there is sufficient contact surface area between the loop strips 50 and the hook strips 40, such that external forces such as wind, gravity, or the force exerted by the relaxation of the plant 80 within the protector 10 will not cause the hook and loop fastening bond 2 to fail and expose the plant 80.

There are a variety of lengths and positions in which the hook strips 40 and loop strips 50 can be affixed to the sheet 20, as there are a variety of configurations and sizes available for the sheet 20.

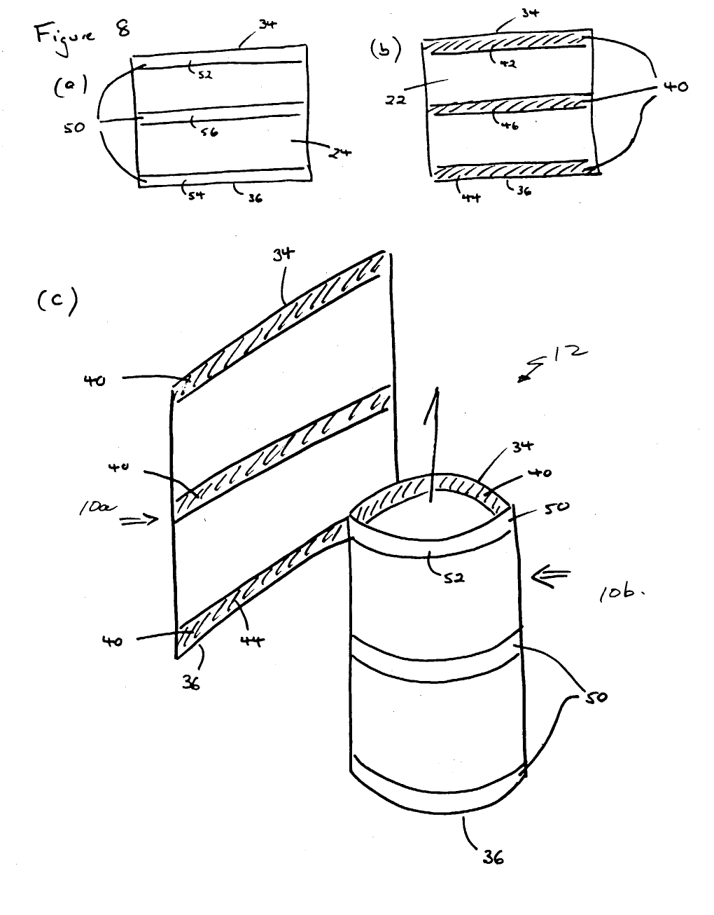

In the event the circumference of the plant 80 is greater than the length of the sheet 20, making it impossible to envelop the plant 80 with one such sheet 20, it is possible to meet the desired length requirement by fastening a plurality of protectors 10 together in order to envelop the plant 80, as illustrated in FIGS. 7(a) and (b), to form a composite protector 12. Two such protectors 1Oa and 10b have been joined together in FIG. 7(a), three protectors 1Oa, 10b, and 10c in FIG. 7(b) to form a composite protector 12.

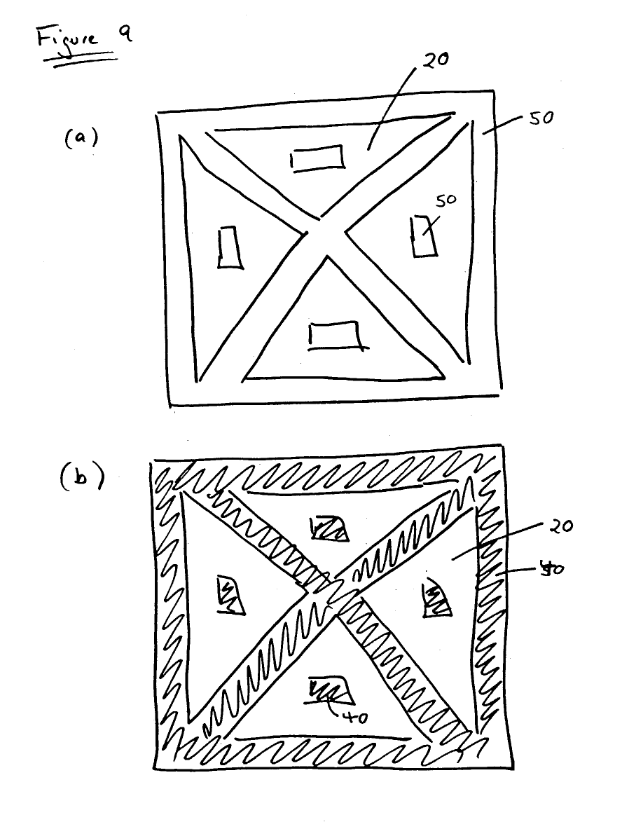

While FIGS. 7(a) and (b) provide examples of increasing the length of composite protector 12, it is also within the scope of the invention to have a plurality of protectors 10 increase the overall height of protection. Increasing the height of protection may entail the use of a plurality of protector units 10 having hook strips 40 and loop strips 50 affixed along the entire length of both the top 34 and bottom edges 36 of the sheet, as illustrated in FIGS. 8(a) and (b) to form a composite protector 12. As one of these protectors 10 is wrapped around a plant, another protector 10 can be wrapped immediately above it, having the bottom edge hook strip 44 of the upper protector 10a engage with the top edge loop strip 52 of the lower protector 10b, as illustrated in FIG. 8(c). In this embodiment, the hook strips 40 and loop strips 50 are shown as extending continuously from the leading edge 30 to the trailing edge 32. In an alternate embodiment, not illustrated, these continuous strips could be replaced with a plurality of shorter individual strips.

Most conveniently, it has been found useful to manufacture protectors 10 from sheets of burlap having a height of 3 feet and a length of 9 feet. The 9 foot length will handle plants with a diameter of little less than 3 feet. If the plant to be protected is larger in diameter, then a second or third protector 10 is used as shown in FIGS. 7(a) and 7(b) respectively. Three such protectors 10, when joined, will handle a plant just under 27 feet in circumference, or just under 9 feet in diameter.

With hook and loop strips, 40, 50 at top and bottom edges 34, 36, and at least one hook strip 46 and one loop strip 56 at an area between these edges, these protectors can be joined together, as shown in FIG. 8, to protect plants 6 feet tall (2 protectors), 9 feet tall (3 protectors), or larger as needed. It is noted that with this kind of arrangement,.the hook strips 40 and loop strips 50 will be affixed completely opposite each other on the sheet 20. Thus, one 3×9 sheet 20 can be used alone for smaller plants, or a plurality of sheets can be used together for plants which are greater in circumference than 9 feet and/or taller than 3 feet. This facilitates stocking requirements for retailers.

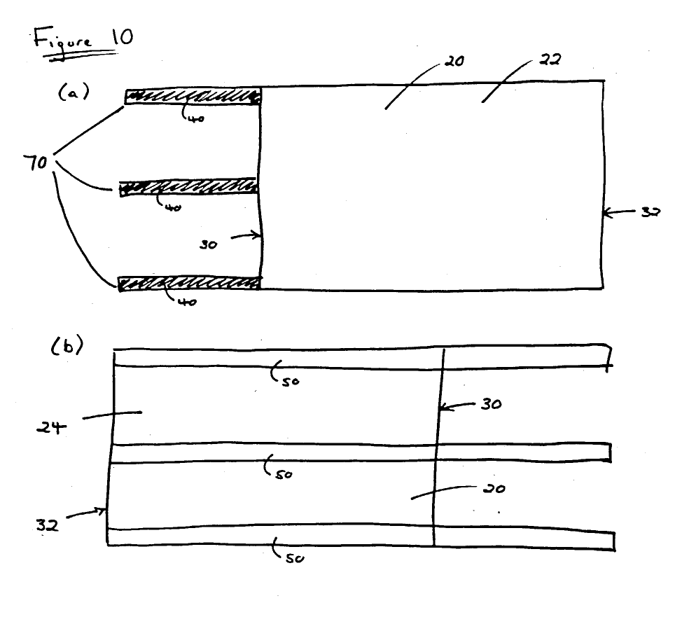

Various plants or sections of plants, such as root bulbs or awkwardly shaped hedged plants, may not have a convenient shape for wrapping. It may thus be desirable to have a configuration of hook strips 40 and loop strips 50 that are affixed to sheets 20 diagonally, intermittently, or on the periphery, in order to better enable one to wrap plant matter that is not longitudinal in shape. An example of such a hook and loop strip 40, 50 configuration is found in FIGS. 9(a) and (b).

Another embodiment of the invention is illustrated in FIGS. 10(a) and (b). The interior surface 22 has no hook strips 40 affixed to the sheet 20, whereas the exterior surface 24 has loop strips 50 affixed as lengthwise strips. The difference between this embodiment and that previously described is that there are attached to the leading edge 30 of the sheet 20 hook straps 70. Once again the trailing edge 32 is placed against the plant 80, but instead of the overlapping portion 60 creating the fastening connection 62, securing the sheet 20 in place, it is the hook straps 70 that create this bond.

While in this description of the preferred embodiments the hook strips 40 are on the interior surface 22 and the loop strips 50 are on the exterior surface, these are switchable as desired.

Although the invention has been described and illustrated in detail, it is to be clearly understood that the same is by way of illustration and example, and is not to be taken by way of limitation. The spirit and scope of the invention are to be limited only by the terms of the appended claims.

1. A plant protector, said protector comprising:
at least one sheet of material, said sheet of material having first and second surfaces, and said sheet of material having a periphery defined by a top edge, a bottom edge, a leading edge and a trailing edge, and a hook and loop fastener system including at least one strip of hook component portion and at least one strip of loop component portion wherein at least one of said strip of hook component portions is on one of said first and second surfaces of said sheet of material, and at least one of said strip of loop component portions is on the other of said first and second surfaces of said sheet of material and wherein said strips of hook and loop component portions are located on said surfaces of said sheet of material so as to be inter-engageable upon wrapping said sheet of material around at least a section of a plant to be protected.

2. The protector of claim 1, wherein the said sheet of material is comprised of burlap.

3. The protector of claim 1, wherein the said sheet of material is porous.

4. The protector of claim 1, wherein said sheet of material includes at least two of said strips of hook component portions, wherein one of said strips of hook component portions extends along at least a portion of the top edge of said sheet of material, and one of said strips of hook component portions extends along at least a portion of the bottom edge of said sheet of material.

5. The protector of claim 1, wherein said hook and loop fastener system is located on said sheet so that at least some of said loop portion is engageable with at least some of said hook portion to hold said sheet of material in a tube configuration when said sheet is wrapped around a plant.

6. The protector of claim 1, wherein said sheet of material is generally rectangular.

7. The protector of claim 1, wherein at least one of said strips of hook component portions is adjacent to said periphery of said sheet of material.

8. The protector of claim 7, wherein at least one of said strips of loop component portions is adjacent to said periphery of said sheet of material.

9. The protector of claim 1, wherein there is a plurality of said hook component portions on said first or second side of said sheet of material.

10. The protector of claim 1, wherein there is a plurality of said loop component portions on said first or second side of said sheet of material.

11. The protector of claim 1, wherein at least one of said strips of hook component portions is located on said sheet of material on an angle that is neither perpendicular nor parallel with said periphery.

12. The protector of claim 1, wherein at least one of said strips of loop component portions is located on said sheet of material on an angle that is neither perpendicular nor parallel with said periphery.

13. A composite protector, wherein said composite protector comprises a plurality of protectors in accordance with claim 1, located such that the hook component portion on one of said protectors is inter-engageable with the loop component portion on another one of said protectors.

14. The composite protector of claim 13 wherein at least two of said protectors are fixed together with the trailing edge of a first protector joined to the leading edge of a second protector by interengagement of portions of said hook and loop fastener systems.

15. The composite protector of claim 13 wherein at least two of said protectors are fixed together with the bottom edge of a first protector joined to the top edge of a second protector by interengagement of portions of said hook and loop fastener systems.

16. A method of protecting a plant comprising wrapping a sheet of material about at least one section of a plant, said sheet having a hook component portion and a loop component portion, and adhering at least some of the hook component portion with at least some of the loop component.

17. The method of claim 16, wherein a plurality of said sheets of material are used to wrap a plant, wherein the leading edge of one sheet is placed in adherence to the trailing edge of a second sheet.

18. The method of claim 16, wherein a plurality of said sheets of material are used to wrap a plant, wherein the top edge of one sheet is adhered to the bottom edge of a second sheet.
